(19) United States
(12) Patent Application Publication
(10) Pub. No.: US 2008/0056470 A1
(43) Pub. Date: Mar. 6, 2008

(54) MAIL-EDITING SYSTEM AND METHOD

(75) Inventors: Chaucer Chiu, Taipei (TW); Clark Yu, Taipei (TW)

Correspondence Address: LAW OFFICES OF MIKIO ISHIMARU, 333 W. EL CAMINO REAL, SUITE 330, SUNNYVALE, CA, 94087, US

(73) Assignee: INVENTEC CORPORATION, Taipei (TW)

(21) Appl. No.: 11/567,569

(22) Filed: Dec. 6, 2006

(30) Foreign Application Priority Data
Aug. 10, 2006 (TW) 095129320

(51) Int. Cl. H04M 11/00

(52) U.S. Cl. 379/93.17

(57) ABSTRACT

A mail editing system and method create an icons database, which is capable of storing at least an emotion data, wherein, the emotion data consists of an emotion, an emotion code, and an emotion meaning; next, establishes a relation between the recipient of the attached emotion data and the emotion meaning of the emotion data, and based on the relation, creates a corresponding relation table of icons; then, based on the recipient of the attached emotion data of an electronic mail edited by the sender of the mail, looks up in the created relation table of icons in order to obtain the emotion meaning corresponding to the recipient of the attached emotion data; at last, based on the obtained emotion meaning, acquires the emotion and emotion code corresponding to the emotion meaning from the icons database and then adds both the emotion and the emotion code to the electronic mail.

### BACKGROUND OF THE INVENTION

1. Field of the Invention

This invention relates generally to mail editing techniques, and more particularly, to a mail editing system and method capable of adding emotions to an electronic mail.

2. Description of Related Art

Most of the computers, cellular phones, and personal digital assistants (PDA) include an electronic mail transceiver, and the electronic mail provides many advantages, such as convenience, fast speed, less cost, a massive amount of delivery, and no restriction on time, etc., therefore, the electronic mail has become one of the major means of communications and interactions for people in the present era.

However, in the present day, the content of the electronic mail is all filled with words only; therefore there comes some disadvantages, such as limited emotional expressions, vague communication of emotions, and lack of emotional interactions, etc.

Specifically, when the sender of a mail is writing an electronic mail with some specific meanings and emotions, the common situation is that he/she has limited vocabularies to fully express the complete meanings of his/her personal emotions, or sometimes, in order to save time, the sender has to write down the indicative sentences only, without suitable words for describing the personal expressions of emotions, the result of those situations mentioned above is an electronic mail of limited and vaguely emotional expressions, meanwhile, the receiver of the electronic mail can not fully or accurately understand the emotions of the sender of the mail.

On the other hand, if the receiver of an electronic mail receives a mail with vague or without expressions of emotions, he/she will judge the state of emotion of the sender by his/her own personal feeling, that is to say, the emotion of the receiver affects his/her judgment on the state of the emotion of the electronic mail sender, for example, if the sender sends an ordinary electronic mail (e.g. without any emotional expression), and at the time that the receiver receiving the mail is at a negative mood (e.g. anger), there is a high possibility that the receiver considers the mail he/she just received is a negative one, therefore, there comes out an unnecessary misunderstanding in the emotional communication between the sender and the receiver of the mail.

For the reasons mentioned above, in order to edit an electronic mail with expressions of emotions, how to provide a mail editing system and method capable of indicating emotion of the electronic mail has become a highly urgent problem to be solved.

### SUMMARY OF THE INVENTION

In view of the disadvantages of the prior art mentioned above, it is a primary objective of the present invention to provide a mail editing system and method, which is capable of adding emotions to an electronic mail, thereby creating an electronic mail with expressions of emotions.

It is another objective of the present invention to provide a mail editing system and method, which is capable of furnishing the sender of the electronic mail with the advantages of emotional expressions, thereby enhancing the emotional communication between the sender and the receiver of the electronic mail.

To achieve the above-mentioned and other objective, a mail editing system and method is provided according to the present invention, the mail editing system comprises: an icons database, which is used to store at least an emotion data, wherein, the emotion data includes an emotion, an emotion code, and an emotion meaning; a setting module, which is used to establish a relation between the recipient of the attached emotion data in the icons database with emotion meaning of the emotion data, and then create a corresponding relation table of icons based on the established relation; an analysis module, which is used to analyze the recipient of the attached emotion data of the electronic mail edited by the sender of the mail, and based on the recipient of the attached emotion data, look up in the relation table of icons created by the setting module in order to obtain the emotion meaning corresponding to the recipient of the attached emotion data; and an addition module, which is used to, based on the emotion meaning obtained by the analysis module, acquire the emotion and emotion code corresponding to the emotion meaning from the emotion data in the icons database and then add the emotion and emotion code to the electronic mail.

Wherein, the recipient of the attached emotion data is the receiver of an electronic mail or a key message in the electronic mail content; the process of adding the emotion and emotion code, which are corresponding to the emotion meaning, into the electronic mail includes: adding the emotion to the content display window of the electronic mail and adding the emotion code into the mailing code of the electronic mail.

In a better exemplary embodiment, the emotion data further includes a scale of the state of emotion; and the mail editing system further comprises a recording module, which is used to, based on the emotion meaning of the electronic mail, record the scale of the state of emotion corresponding to the emotion meaning, thereby generating a statistic data of the state of emotion.

Besides, the mail editing system in the present invention further comprises a switching module, which is used to provide an enable/disable switch for the analysis module and the addition module to process the enable/disable function.

The mail editing method of the present invention comprises the following steps: (1) create an icons database for storing at least an emotion data, wherein, the emotion data includes an emotion, an emotion code, and an emotion meaning; (2) establish a relation between the recipient of the attached emotion data that is stored in the icons database and the emotion meaning in the emotion data, and then based on the established relation, create a corresponding relation table of icons; (3) analyze the recipient of the attached emotion data of the electronic mail that is edited by the sender of the mail, and based on the information of the recipient of the attached emotion data, acquire the emotion meaning corresponding to the recipient of the attached emotion data; and (4) based on the obtained emotion meaning, acquire the emotion and emotion code corresponding to the emotion meaning from the emotion data in the icons database and then add both the emotion and the emotion code to the electronic mail.

In the step of (4), wherein, further comprises: (4-1) add the emotion, which is corresponding to the emotion meaning, into the content display window of the electronic mail this is edited by the sender of the mail, and (4-2) in the process of sending the electronic mail, add the emotion code, which is corresponding to the emotion meaning, to the mailing code of the electronic mail.

In a better exemplary embodiment, the emotion data further comprises a scale of the state of the emotion; and the mail editing method further comprises a step of, based on the emotion meaning of the electronic mail, recording the scale of the state of the emotion corresponding to the emotion meaning, thereby generating a statistic data of the state of emotion.

The features of the mail editing system and method in the present invention are: automatically add in the corresponding icons based on the recipient of the attached emotion data, specifically, it is based on the receiver of an electronic mail or the key messages of the content of the electronic mail, automatically add the related emotions to the electronic mail, thereby creating an electronic mail with expressions of emotions. By sending an electronic mail with emotional expressions, the sender does not have to spend time and energy in wording in order to describe a specific emotion, by adding an emotion, the sender can express his/her state of emotion simply, clearly, and directly; meanwhile, the receiver can understand the state of emotion of the sender precisely and then responds timely with an electronic mail with expressions of emotions as well, further to enhance the interaction and communication of emotions between the sender and the receiver of the mail.

Further more, the sender of the electronic mail can grasp his/her personal state of emotion and emotional tendency by the indication of the statistic diagram of the state of emotion, which is generated in the present invention, and then adjust his/her personal emotion duly, consequently, thereby enhancing his/her personal performance in daily life, work, and learning.

### BRIEF DESCRIPTION OF DRAWINGS

The present invention can be more fully understood by reading the following detailed description of the preferred embodiments, with reference made to the accompanying drawings, wherein:

FIG. 1 is a structure block diagram of an exemplary embodiment of a mail editing system according to the present invention;

FIGS. 2A to 2D are diagrams of an exemplary embodiment of a transceiver system of electronic mails in a mail editing system according to the present invention; and

FIGS. 3A and 3B are detailed flowcharts of an exemplary embodiment of a mail editing method according to the present invention.

### DETAILED DESCRIPTION OF PREFERRED EMBODIMENTS

The following illustrative embodiments are provided to illustrate the disclosure of the present invention, these and other advantages and effects can be apparently understood by those in the art after reading the disclosure of this specification. The present invention can also be performed or applied by other different embodiments. The details of the specification may be on the basis of different points and applications, and numerous modifications and variations can be devised without departing from the spirit of the present invention.

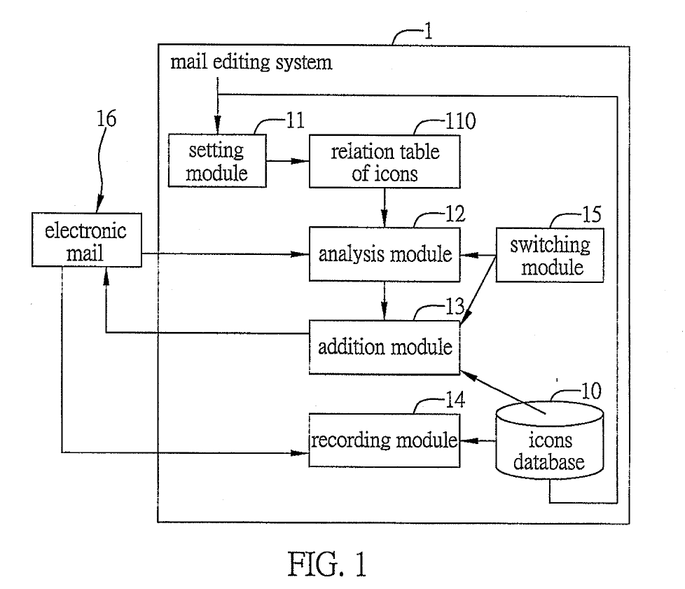

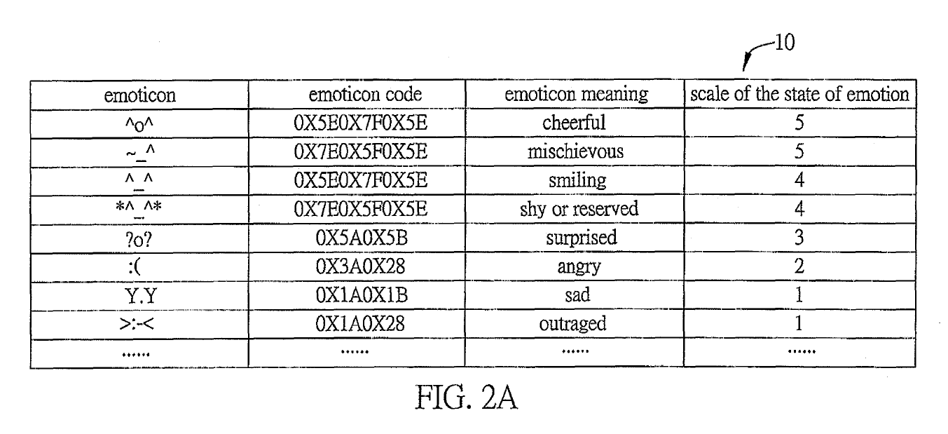

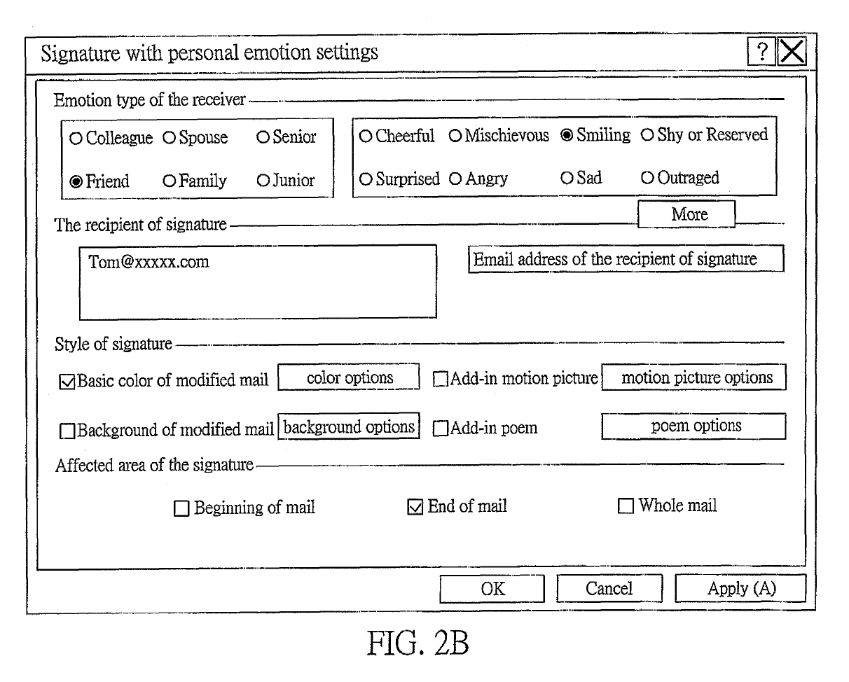

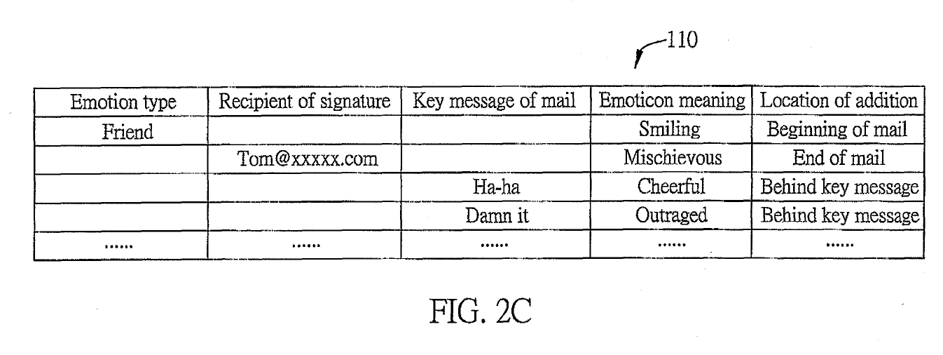

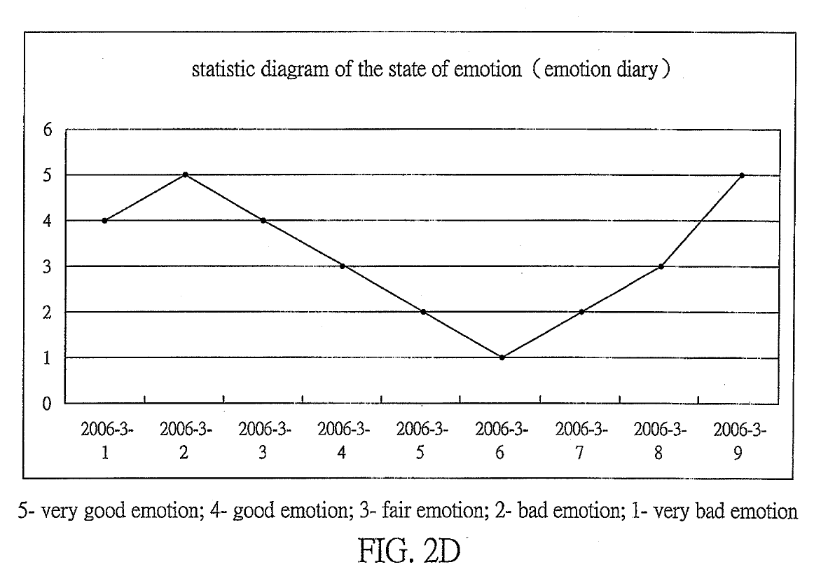

FIG. 1 is a basic structure block diagram of an exemplary embodiment of a mail editing system 1 according to the present invention. The mail editing system 1 of the present invention is applicable to an electronic device, such as a computer, a cellular phone, and, a personal digital assistant (PDA), which are capable of receiving/sending electronic mails. As illustrated in FIG. 1, the mail editing system 1 comprises an icons database 10, a setting module 11, an analysis module 12, an addition module 13, a recording module 14, and a switching module 15. Followed is the detail description of each module in the mail editing system 1, in accordance with FIGS. 2A to 2D, which are diagrams of an exemplary embodiment of a transceiver system of electronic mails in a mail editing system according to the present invention,

The icons database 10 is used to store icon data, which include an icon, an icon code, and an icon meaning. In the present exemplary embodiment, the icon data are emotion data, as shown in FIG. 2A, which displays the icons database 10 storing a plurality of emotion data, and each of the emotion data includes an emotion, an emotion code, an emotion meaning, and a scale of the state of emotion. As shown in the figure, the emotion meaning includes: cheerful, mischievous, smiling, shy or reserved, surprised, angry, sad, outraged, etc.; besides, the scale of the state of emotion in the emotion data is used to evaluate the state of emotion corresponding to the emotion data, for instance, a scale of the state of emotion of “5” means that the state of emotion is very good, a scale of the state of emotion of “4” means that the state of emotion is good, a scale of the state of emotion of “3” means that the state of emotion is fair, a scale of the state of emotion of “2” means that the state of emotion is bad, and a scale of the state of emotion of “1” means that the state of emotion is very bad.

The setting module 11 is used to set a relation between the icon meaning and the information of each recipient of the attached emotion data and then based on the relation, and create a corresponding relation table of icons 110. In the present exemplary embodiment, the information of the recipient of the attached emotion data is the information of an electronic mail receiver, such as the electronic mail address of the receiver of the electronic mail; and the recipient of the attached emotion data can also be a key message of the electronic mail content as well, such as any key word included in the content of the mail that is edited by the sender. In the present exemplary embodiment, the setting module 11 provides a display window for setting the relation between the receiver of the electronic mail and the emotion meaning (as shown in FIG. 2B) as well as a display window for setting the relation between the key words of the mail content and the emotion meaning (not shown herein), the setting module 11 displays the provided display windows on the screen of the electronic device; besides, the setting module 11 also provides a list of emotions (can be displayed on the content display window of the electronic mail, namely, content editing window), the list of emotions provides the sender a convenient way to choose a suitable emotion (or emotion meaning) directly while editing an electronic mail.

Please refer to FIG. 2B, which is a display window for the sender (person who writes the mail) to setup the information of the receiver of the electronic mail and the emotions to be added to the electronic mail, this is to say, it is the display window provided for the sender to establish a signature with personal emotion, wherein, the sender can choose many receivers and set the suitable emotion meanings to be attached as well, the emotion type of the receiver includes “colleague”, “spouse”, “senior”, “friend”, “lover”, and “junior”, etc., and the emotion meaning includes “smiling”, “mischievous”, “cheerful”, and “outraged”, etc, wherein, the sender can set the same emotion meanings for many different recipients, or set different emotion meanings for different recipients, that is to say, it all depends on the need of a real situation. Besides, the sender can also choose a location (any area affected by the signature with personal emotion) for attaching the emotion, for example, in the beginning of the mail, at the end of the mail, or any spot throughout the whole mail. Please continue to refer to FIG. 2C, which is a relation table of icons 110 created by the setting module 11 based on the relation defined by the sender of mail between the recipient of the attached emotion data and the emotion meaning. As shown in the figure, the emotion type of the receiver is “friend”, the emotion meanings corresponding to the emotion type of the receiver include “smiling”, “mischievous”, “cheerful”, and “outraged”; further more, the recipient of the signature with personal emotion is set as Tom@yahoo.com, and the key words of the mail content are “Ha-ha” and “damn it”.

The analysis module 12 is used to analyze the recipient of the attached icon (namely, the receiver of the mail) of an electronic mail 16, and then based on the recipient of the attached emotion data, the analysis module 12 looks up in the relation table of icons 110 created by the setting module 11 in order to acquire the emotion meaning corresponding to the recipient of the attached emotion data. For example, if the emotion type of the receiver of the electronic mail 16 is “friend”, based on the above-mentioned relation table of icons 110, the analysis module 12 acquires the corresponding emotion meaning, which is “smiling”; if there is a key message “Ha-ha” in the content of the electronic mail 16, then based on the above-mentioned relation table of icons 110, the analysis module 12 acquires the corresponding emotion meaning, which is “cheerful”.

The addition module 13 is used to, based on the emotion meaning obtained by the analysis module 12, acquire the emotion and emotion code corresponding to the emotion meaning from the icons database 10 and then add the emotion and emotion code to the electronic mail 16. Wherein, the process of adding the emotion and emotion code, which are corresponding to the emotion meaning, to the electronic mail 16 includes adding the emotion to the content display window (the editing window) of the electronic mail 16 and adding the emotion code to the mailing code of the electronic mail 16. In the present exemplary embodiment, the addition module 13 acquires the emotions “̂-̂” and “̂ô”, which are corresponding to the previously mentioned emotion meanings “smiling” and “cheerful” respectively, from the icons database 10 and then adds both acquired emotions to the content display window, which displays the content of the electronic mail 16, for instance, “̂-̂” is added in the begging of the mail and “̂ô” is added right behind word “Ha-ha; besides, when the sender decides to send the mail, the transceiver system of electronic mails of the electronic device will code the electronic mail, at this moment, the addition module 13 acquires the emotion codes “0X5E0X5F0X5E” and “0X5E0X7F0X5E”, which are corresponding to the previously mentioned emotion meanings “smiling” and “cheerful” respectively, from the icons database 10 and then add both emotion codes to the mailing code of the electronic mail, next, the transceiver system of the electronic device delivers the mailing code of the electronic mail 16 to the receiver of the mail.

The recording module 14 is used to, based on the emotion meaning of the electronic mail 16, record the corresponding scale of the state of emotion of the emotion data that is stored in the icons database 10, thereby generating a statistic data of the state of emotion, FIG. 2D is a statistic diagram of the state of emotion, which illustrates the statistic data of the state of emotion in the present exemplary embodiment. When the electronic mail is sending out, the recording module 14 acquires the emotion (or emotion meaning) of the electronic mail 16 and then acquires the scale of the state of emotion corresponding to the acquired emotion meaning from the icons database 10, next, records the acquired scale of the state of emotion, the recording module 14 can record the scale of the state of emotion of the sender every day, thereby generating a statistic diagram of the state of emotion (namely, an emotion log), as shown in FIG. 2D. The sender of the electronic mail can grasp his/her personal state of emotion and emotional tendency by the indication of the statistic diagram of the state of emotion, and adjust his/her personal emotion duly, consequently, enhance his/her personal performance in daily life, work, and learning.

The switching module 15 is used to provide with an enable/disable switch for the analysis module 12 and addition module 13 to process the enable/disable function. In other words, in the process of editing of the electronic mail 16, the switching module 15 provides the sender of the electronic mail with the control of the enable/disable switch for adding the emotion based on the need of the sender.

The switching module 15 further selectively executes a display process on an emotion of an electronic mail having an emotion meaning. Therefore, the receiver, after receiving the electronic mail, is allowed to selectively execute the display process on the emotion of the electronic mail, and is free from the interference resulting from the unexpected display of the emotion.

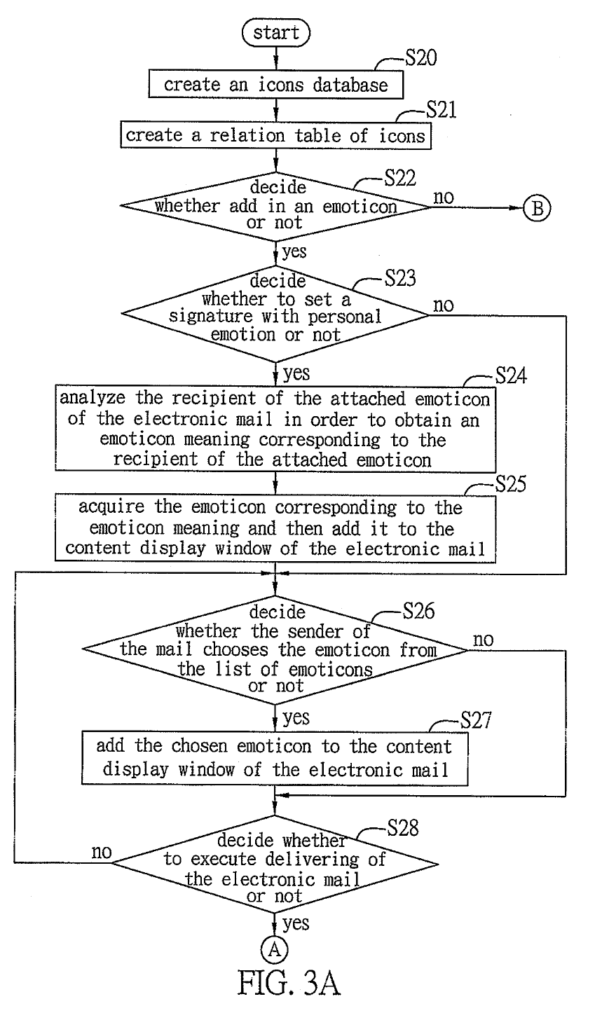

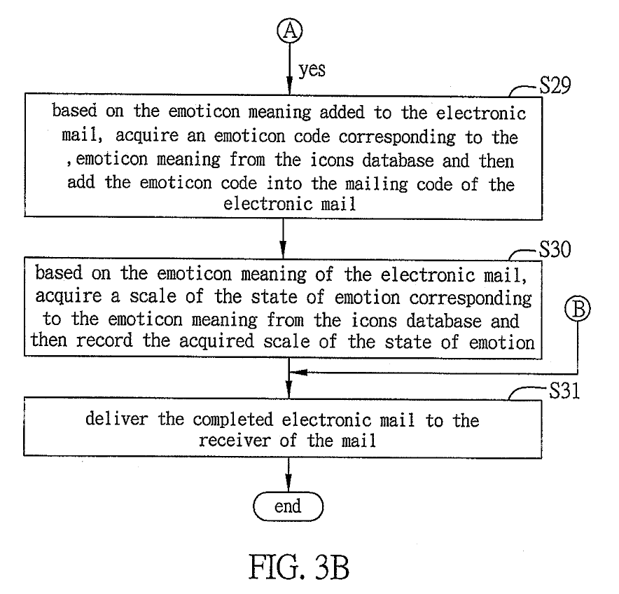

Corresponding to the above-described mail editing system 1, the present invention further provides a mail editing method, please refer to FIGS. 3A and 3B, which are a detailed flowchart of an exemplary embodiment of a mail editing method according to the present invention, and followed is the detailed steps of the flow of the mail editing method according to the present invention. The process begins at step S20.

In step S20, create an icons database, for storing a plurality of icon data, wherein, the icon data is an emotion data that comprises an emotion, an emotion code, an emotion meaning, and a scale of the state of emotion. Proceed to step S21.

In step S21, set a relation between each recipient of the attached emotion data and the emotion meaning, and based on the relation, create a corresponding relation table of icons. Wherein, the recipient of the attached emotion data can be the receiver of the electronic mail or any key words (messages) of the electronic mail content, in the present exemplary embodiment, set a relation between the recipient of the attached emotion data and the emotion meaning, and create a corresponding relation table of icons, and based on the created relation table of icons, establish a signature with personal emotion of the sender of the electronic mail. Proceed to step S22.

In step S22, in the process that the sender is editing of the electronic mail, decide whether the sender activates the function of adding emotions to the electronic mail, if yes, proceed to step S23; otherwise, proceed to step S31 as illustrated in FIG. 3B.

In step S23, decide whether the sender of the electronic mail creates a signature with personal emotion, specifically, whether the sender of the electronic mail establishes, for the receiver of the mail, a relation between the receiver and the emotion meaning, or, whether the sender of the electronic mail creates a relation between any key words of the electronic mail content and the emotion meaning, if yes, proceed to step S24; otherwise, proceed to S26.

In step S24, analyze the recipient of the attached emotion data of the electronic mail that is edited by the sender of the mail (including the receiver of the electronic mail and any key words of the electronic mail content), and based on the recipient of the attached emotion data, look up in the relation table of icons 110 in order to obtain the emotion meaning corresponding to the recipient of the attached emotion data. Proceed to step S25.

In step S25, based on the obtained emotion meaning, acquire the emotion corresponding to the emotion meaning from the emotion data in the icons database 10 and then add the emotion to the content display window (editing window) of the electronic mail edited by the sender. Proceed to step S26.

In step S26, decide whether the sender chooses an emotion, which is an icon corresponding to an emotion meaning, from the list of emotions (not shown herein), if yes, proceed to step S27; otherwise, proceed to step S28.

In step S27, based on the chosen emotion meaning, acquire the emotion corresponding to the emotion meaning from the emotion data in the icons database 10 and then add the emotion to the content display window of the electronic mail edited by the sender. Proceed to step S28.

In step S28, decide whether to execute the process of sending the mail that is edited by the sender, if yes, proceed to step S29 as shown in FIG. 3B; otherwise, proceed back to step S26.

In step S29, based on the emotion meaning added to the electronic mail, acquire the emotion code corresponding to the emotion meaning from the icons database 10 and then add the emotion code to the mailing code of the electronic mail that is edited by the sender. Proceed to step S30.

In step S30, based on the emotion (or emotion meaning) of the electronic mail, acquire the scale of the state of emotion corresponding to the emotion meaning, and record the scale of the state of emotion, thereby generating a statistic diagram of the state of emotion. Proceed to step S31.

In step S31, send the electronic mail (mailing code) edited by the sender to the receiver of the mail.

In summary, the features of the mail editing system and method in the present invention are: based on the recipient of the attached emotion data, automatically add in the corresponding icons, specifically, it is based on the receiver of an electronic mail or the key messages of the content of the electronic mail, automatically add the related emotions to the electronic mail, thereby creating an electronic mail with expressions of emotions. By sending an electronic mail with emotional expressions, the sender does not have to spend time and energy in wording in order to describe a specific emotion, by adding an emotion, the sender can express his/her state of emotion simply, clearly, and directly; meanwhile, the receiver can understand the state of emotion of the sender precisely, and responds timely with an electronic mail with expressions of emotions as well, further to enhance the interaction and communication of emotions between the sender and the receiver of the mail.

Further more, the sender of the electronic mail can grasp his/her personal state of emotion and emotional tendency by the indication of the statistic diagram of the state of emotion, which is generated in the present invention, and then adjust his/her personal emotion duly, consequently, enhance his/her personal performance in daily life, work, and learning.

The foregoing descriptions of the detailed embodiments are only illustrated to disclose the features and functions of the present invention and not restrictive of the scope of the present invention. It should be understood to those in the art that all modifications and variations according to the spirit and principle in the disclosure of the present invention should fall within the scope of the appended claims.

What is claimed is:

1. A mail editing system comprising:
an icons database for storing emotion data comprising an emotion, an emotion code, and an emotion meaning;
a setting module for setting a relation between a recipient of attached emotion data in the icons database and the emotion meaning of the emotion data, and creating a corresponding relation table of icons based on the relation;
an analysis module for analyzing the recipient of the attached emotion data of an electronic mail that is edited by a sender of the electronic mail, and looking up in the relation table of icons created by the setting module based on the recipient of the attached emotion data, to acquire the emotion meaning corresponding to the recipient of the attached emotion data; and
an addition module for acquiring the emotion and emotion code corresponding to the emotion meaning from the emotion data in the icons database based on the emotion meaning acquired by the analysis module, and adding the acquired emotion and emotion code to the electronic mail.

2. The mail editing system of claim 1, wherein, the emotion data further comprises a scale of the state of emotion.

3. The mail editing system of claim 2 further comprising a recording module for recording the scale of the state of emotion corresponding to the emotion meaning based on the emotion meaning of the electronic mail, thereby creating a statistic data of the state of emotion.

4. The mail editing system of claim 1, wherein, the recipient of the attached emotion meaning is one of a receiver of the electronic mail and key messages of the electronic mail.

5. The mail editing system of claim 1, wherein, the process of adding the emotion and the emotion code, which are corresponding to the emotion meaning, to the electronic mail includes: adding the emotion to the content display window of the electronic mail, and adding the emotion code to the mailing code of the electronic mail.

6. The mail editing system of claim 1, wherein, further comprises a switching module, which provides with an enable/disable switch for the analysis module and addition module to process the enable/disable function

7. A mail editing method comprising:
creating an icons database for storing emotion data comprising an emotion, an emotion code, and an emotion meaning;
setting a relation between a recipient of the attached emotion data in the icons database and the emotion meaning in the emotion data, and creating a corresponding relation table of icons based on the relation;
analyzing the recipient of the attached emotion data of an electronic mail edited by a sender of the electronic mail, and looking up in the relation table of icons based on the recipient of the attached emotion data to obtain the emotion meaning corresponding to the recipient of the attached emotion data; and
acquiring the emotion and emotion code corresponding to the emotion meaning from the emotion data in the icons database based on the emotion meaning, and adding both the emotion and the emotion code to the electronic mail.

8. A mail editing method of claim 7, wherein, the emotion data further comprises a scale of the state of emotion.

9. A mail editing method of claim 8 further comprising recording the scale of the state of emotion corresponding to the emotion meaning, wherein based on the emotion meaning of the electronic mail, thereby generating a statistic data of the state of emotion.

10. A mail editing method of claim 7, wherein the recipient of the attached emotion meaning is one of a receiver of the electronic mail and key messages of the electronic mail.

11. A mail editing method of claim 7, wherein acquiring the emotion and emotion code corresponding to the emotion meaning from the emotion data in the icons database based on the obtained emotion meaning further comprising:
adding in the emotion, which is corresponding to the emotion meaning, to the content display window of the electronic mail; and
adding in the process of sending the electronic mail the emotion code, which is corresponding to the emotion meaning, to the mailing code of the electronic mail.
